(19) United States
(12) Patent Application Publication
(10) Pub. No.: US 2007/0001618 A1
(43) Pub. Date: Jan. 4, 2007

(54) Driving apparatus for lamp of liquid crystal display device

(75) Inventors: Jin Hwan Jeon, Gyeonggi-do (KR); Hoon Jang, Gyeonggi-do (KR)

Correspondence Address: MORGAN LEWIS & BOCKIUS LLP, 1111 PENNSYLVANIA AVENUE NW, WASHINGTON, DC, 20004, US

(73) Assignee: LG.Philips LCD CO., Ltd.

(21) Appl. No.: 11/297,471

(22) Filed: Dec. 9, 2005

(30) Foreign Application Priority Data
Jun. 30, 2005 (KR) P2005-058221

(51) Int. Cl. H05B 41/24

(52) U.S. Cl. 315/247

(57) ABSTRACT

A backlight driving apparatus comprises a rectifying-smoothing part to convert an AC voltage supplied from a common power source into a DC voltage, a power factor correction circuit part to boost the DC voltage converted from the rectifying-smoothing part, and a DC/AC converter to convert the boosted DC voltage from the power factor correction circuit part into a boosted AC voltage such that the boosted AC voltage drives a backlight.

This application claims the benefit of the Korean Patent Application No. P2005-58221 filed on Jun. 30, 2005, which is hereby incorporated by reference.

### BACKGROUND OF THE INVENTION

1. Field of the Invention

The present invention relates to a lamp driving apparatus of a liquid crystal display device, and more particularly to a method and apparatus for driving a lamp of a liquid crystal display device.

2. Background of the Related Art

Generally, a liquid crystal display (LCD) device includes a liquid crystal display panel having a plurality of liquid crystal cells arranged in matrix and a plurality of control switches. The control switches supply a video signal to each of the liquid crystal cells, such that an amount of transmitted light supplied from a backlight unit to the liquid crystal cells is controlled in order to display a picture.

As shown in FIG. 1, most of the related art LCD devices are manufactured as a transmission type, where a backlight unit 2 is installed on the rear surface of an LCD panel 1. The related art LCD panel 1 controls the transmittance of light incident from the backlight unit 2 to display an image on the LCD panel 1. The light incident from the backlight unit 2 is controlled in accordance with video data. Typically, the related art backlight unit 2 includes a lamp, a light guide panel for converting a linear light source from the lamp into a surface light source, and optical sheets, such as a diffusion sheet, a prism sheet, and other suitable elements to increase the uniformity and efficiency of the light. The power source 3 supplies a power to the inverter. Then the inverter supplies a tube current to the lamp of the backlight unit 2. The lamp of the backlight unit 2 generates an electric discharge within a discharge tube between an anode and a cathode in accordance with the tube current supplied from an inverter 4, thereby generating white light.

FIG. 2 is a block diagram representing a related art device for driving such a backlight unit. As shown in FIG. 2, a rectifying-smoothing part 21 converts an AC voltage applied from a common power source 20 into a DC voltage. The converted DC voltage from the rectifying-smoothing part 21 is boosted to a DC voltage of 400V through a power factor correction (hereinafter, referred to as “PFC”) circuit part 22.

A DC/DC converter 23 reduces the 400V DC voltage, which is boosted through the PFC circuit part 22, down to a low voltage of 24V. An inverter 24 converts and boosts the DC voltage of 24V to an AC voltage of 1000V. The inverter 24 includes a switching block for converting the DC voltage into the AC voltage and a transformer for boosting the voltages.

In processes described above, power is lost at each step of converting the common power into the tube current for driving the backlight. Specifically, in the boosting process at the inverter 24 through the DC/DC converter 23, a voltage boosting ratio is high since the voltage is boosted from 24V to 1000V resulting in a low conversion efficiency.

### SUMMARY OF THE INVENTION

Accordingly, the present invention is directed to a driving apparatus for lamp of liquid crystal display device that substantially obviates one ore more of the problems due to limitations and disadvantages of the related art.

An object of the present invention is to provide a backlight driving apparatus of an LCD device that is adjusted to reduce total power consumption of the LCD device by reducing power loss.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a driving apparatus for lamp of liquid crystal display device includes a backlight driving apparatus comprises a rectifying-smoothing part to convert an AC voltage supplied from a common power source into a DC voltage, a power factor correction circuit part to boost the DC voltage converted from the rectifying-smoothing part, and a DC/AC converter to convert the boosted DC voltage from the power factor correction circuit part into a boosted AC voltage such that the boosted AC voltage drives a backlight.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a diagram illustrating a related art lamp driving apparatus for driving a lamp included in the backlight unit with one inverter;

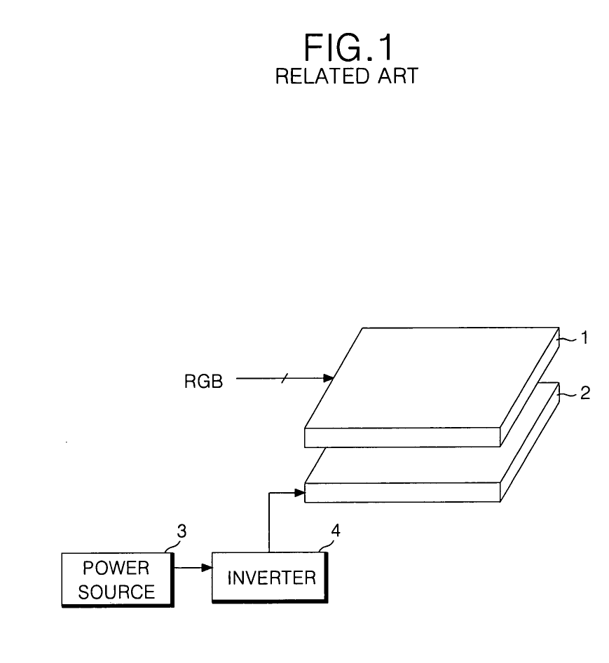

FIG. 2 is a block diagram illustrating a related art lamp driving apparatus;

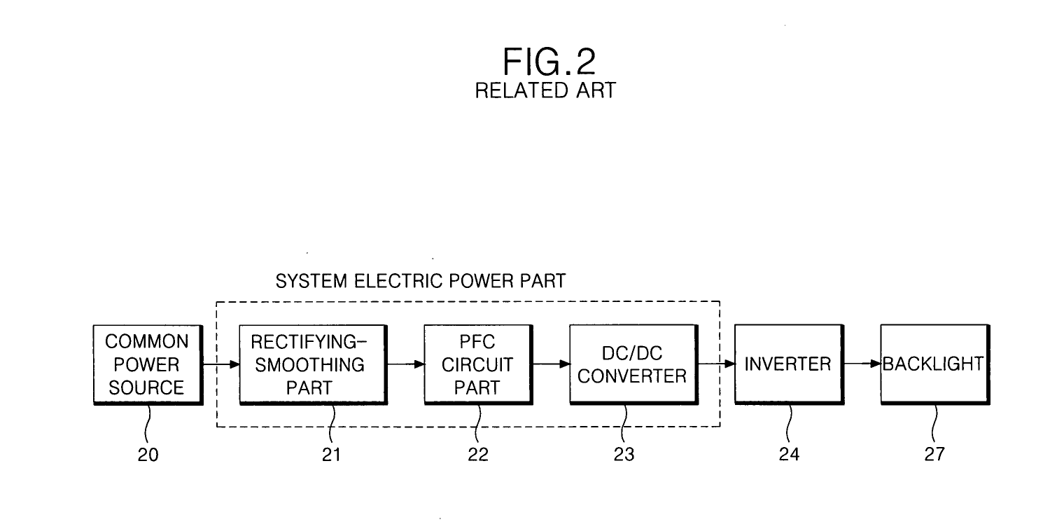

FIG. 3 is a block diagram illustrating a lamp driving apparatus according to an exemplary embodiment of the present invention; and

FIG. 4 is a block diagram illustrating an exemplary system electric power part of FIG. 3 according to the exemplary embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

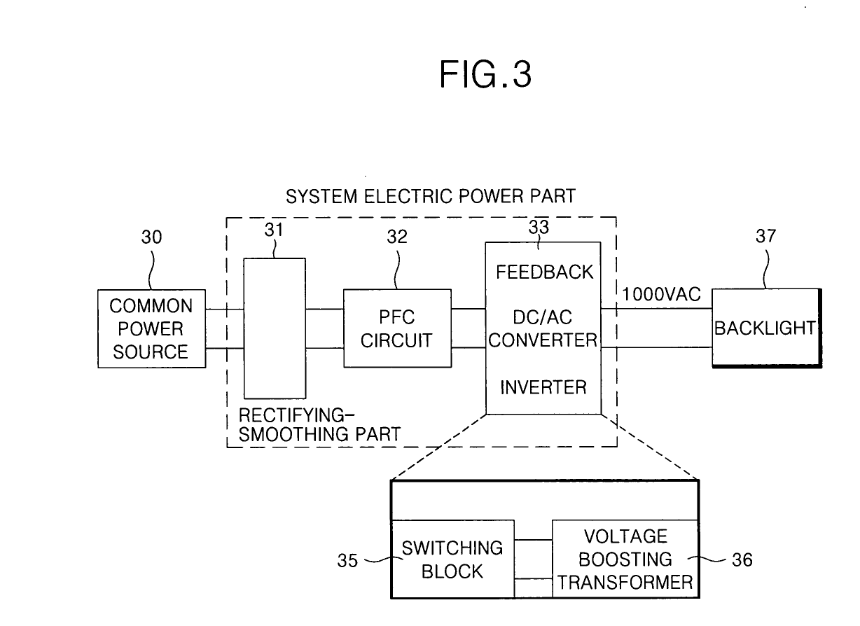

FIG. 3 shows a block diagram illustrating an apparatus for driving a backlight unit according to an exemplary embodiment of the present invention. As shown in FIG. 3, a rectifying-smoothing part 31 converts an AC voltage applied from a common power source 30 into a DC voltage. The converted DC voltage from the rectifying-smoothing part 31 is boosted to a DC voltage of 400V through a PFC circuit part 32. The boosted voltage is transmitted to each driving apparatus that requires a driving voltage in the system.

A DC/AC converter 33 boosts the 400V DC voltage, which is boosted through the PFC circuit part 32, to an AC voltage of 1000V. The DC/AC converter includes a switching block 35 and a voltage boosting transformer 36. The switching block 35 converts the DC voltage of 400V into the AC voltage. The converted AC voltage from the switching block 35 is boosted to a voltage of 1000V through the voltage boosting transformer 36.

In the related art backlight driving apparatus as discussed earlier, the power loss is high due to the high voltage boosting ratio since the voltage of 24V is boosted to the voltage of 1000V. However, the backlight driving apparatus according to the exemplary embodiment of the present invention boosts the DC voltage of 400V to the voltage of 1000V. Thus, the voltage boosting ratio is greatly improved and the power loss is reduced accordingly. A tube current obtained from boosting the AC voltage through the transformer is used as a driving voltage for a backlight 37.

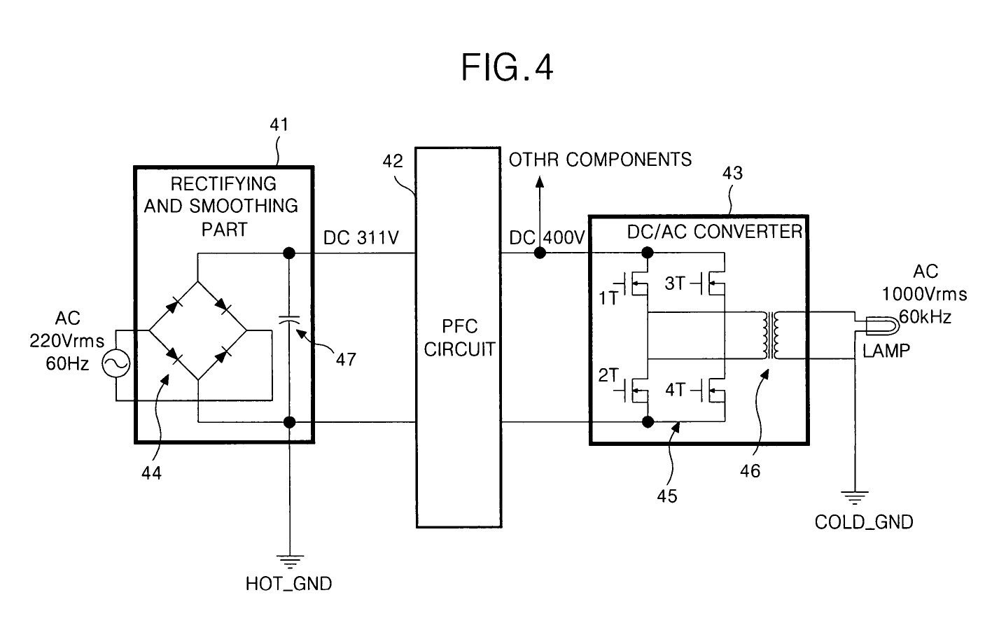

FIG. 4 illustrates an exemplary circuit of the backlight driving apparatus according to the exemplary embodiment of the present invention. As shown in FIG. 4, a rectifying-smoothing part 41 converts an AC voltage (i.e., AC 220V) of a common power source into a DC voltage (i.e., DC 311V). The rectifying-smoothing part 41 includes a bridge diode circuit 44. The converted DC voltage from the rectifying-smoothing part 41 is further converted into a DC voltage of 400V through a PFC circuit 42. The converted 400V DC voltage is transmitted to other components which require the driving voltage within the system. A DC/AC converter 43 includes a switching block 45 for converting the DC voltage to the AC voltage and a voltage boosting transformer 46 for boosting a voltage. The switching block includes first to fourth transistors 1T, 2T, 3T, 4T.

The first and second transistors (1T and 2T) connected in series to each other are directly connected to the PFC circuit 42. The third and fourth transistors (3T and 4T) connected in series to each other are connected parallel to the first and second transistors, respectively. A current path passing through the first and fourth transistors (1T and 4T) and a current path passing through the second and third transistors (2T and 3T) are alternately formed to convert the DC voltage into the AC voltage.

A capacitor 47 is connected between a HOT_GND grounded from the common power source side and a COLD_GND grounded from the backlight side. The HOT_GND is generated when the AC voltage is applied from the common power source. The generated HOT_GND is then converted into the DC voltage and transmitted to a backlight inverter PCB (not shown). If the HOT_GND is directly connected to the COLD_GND, the generated voltage fluctuates. Accordingly, electrical insulation is needed between the two grounds HOT_GND and COLD_GND. In addition, a current path in the backlight side is required to discharge a current to the outside when the current is generated due to an abnormal phenomenon. To satisfy the above requirements, the capacitor 47 is connected between the HOT_GND and the COLD_GND.

As described above, the backlight driving apparatus of the LCD device according to the exemplary embodiment of the present invention reduces the power loss resulting from converting the common voltage into the driving voltage. In addition, the conversion efficiency is improved by lowering the voltage boosting ratio. Furthermore, manufacturing cost is minimized since the inverter is removed.

It will be apparent to those skilled in the art that various modifications and variations can be made in the driving apparatus for lamp of liquid crystal display device of the present invention without departing from the spirit or scope of the invention. Thus, it is intended that the present invention cover the modifications and variations of this invention provided they come within the scope of the appended claims and their equivalents.

What is claimed is:

1. A backlight driving apparatus, comprising:
a rectifying-smoothing part to convert an AC voltage supplied from a common power source into a DC voltage;
a power factor correction circuit part to boost the DC voltage converted from the rectifying-smoothing part; and
a DC/AC converter to convert the boosted DC voltage from the power factor correction circuit part into a boosted AC voltage such that the boosted AC voltage drives a backlight.

2. The backlight driving apparatus according to claim 1, wherein the DC/AC converter includes:
a switching block to convert the boosted DC voltage into a converted AC voltage; and
a transformer to boost the converted AC voltage from the switching block.

3. The backlight driving apparatus according to claim 1, wherein the power factor correction circuit part boosts the DC voltage converted from the rectifying-smoothing part to a DC voltage of 400V.

4. The backlight driving apparatus according to claim 2, wherein the switching block includes:
first and second transistors connected in series to each other and are directly connected to the power factor correction circuit part; and
third and fourth transistors connected in series to each other and are connected in parallel with the first and second transistors, respectively,
wherein a current path passing through the first and fourth transistors and a current path passing through the second and third transistors are alternately formed to convert the boosted DC voltage into the converted AC voltage.

5. The backlight driving apparatus according to claim 2, wherein the transformer boosts the converted AC voltage from the switching block to an AC voltage of 1000V.

6. The backlight driving apparatus according to claim 1, wherein the rectifying-smoothing part includes a bridge diode circuit.
